(19) United States
(12) Patent Application Publication
(10) Pub. No.: US 2017/0202394 A1
(43) Pub. Date: Jul. 20, 2017

(54) Barbecue Grill Cooking System

(71) Applicant: Landmann USA, Fairburn, GA (US)

(72) Inventor: Tom Olsen, Fairburn, GA (US)

(21) Appl. No.: 15/409,794

(22) Filed: Jan. 19, 2017

Related U.S. Application Data
(60) Provisional application No. 62/280,309, filed on Jan. 19, 2016.

(51) Int. Cl. A47J 37/07

(52) U.S. Cl. CPC A47J 37/0704; A47J 37/0786

(57) ABSTRACT

A barbecue grill cooking system is disclosed, having vertically oriented walls forming the firebox, vertically oriented fixture for mounting burner tubes, burner shields, and cooking grates, vertically oriented attachment parts on the burners, and seamless cooking grates having vertically oriented ends, all designed to facilitate grease and cooking debris evacuation.

### CROSS-REFERENCE TO RELATED APPLICATION

This application claims the benefit of U.S. Provisional Application 62/280,309, filed Jan. 19, 2016, which is incorporated herein in its entirety.

### BACKGROUND

Most barbecue grill fireboxes are designed with inwardly angled or inwardly tapering side walls to funnel grease and/or other debris from the cooking process to the bottom levels of the firebox. Typically, the cooking byproducts are directed to a grease cup or tray for removal and disposal. Most fireboxes also include built-in ledges, rails, clips, or other expedients for supporting burners, rock grates, cooking grates and other items.

The angled or tapered walls, ledges, rails, etc., are all prone to collect and retain grease. While this is unsanitary at best, at worst, it is a fire hazard. Any retained grease is liable to ignite, given the right environment, which is deleterious to the grill itself, and any food being cooked thereon, and presents a danger to the operator.

Thus, grease evacuation is an absolute necessity and manufacturers are constantly working to maximize the efficient and safe removal of the hazardous material. While varying degrees of success are achieved, instances of grease fires, flare-ups, and injuries resulting therefrom often occur. It is to these concerns, as well as others, to which the present disclosure is directed.

Disclosed is a barbecue grill cooking system having a plurality of novel features that work in concert to improve the overall cooking performance of barbecue grills, whether the grill is gas-fired, electric, or one that uses solid fuel like wood or charcoal. Certain of the novel components may also be used independently of the others, to individually enhance the performance of barbecue grills.

As shown in the supplied drawings, the present firebox has substantially vertical side walls. The vertical walls present virtually no impediment to the draining of grease from the cooking process. No ledges or like support means for cooking grates are utilized, as all necessary support structures or support means are recessed into the vertical walls or are disposed vertically themselves, as opposed to the common horizontal supports. This construction facilitates the draining and subsequent exit of grease from the firebox, thus greatly reducing or eliminating the possibility of flare-ups and/or grease fires, which are common with prior art barbecue grills.

The firebox itself can be constructed of steel, aluminum, or other heat resistant material. The bottom wall of the firebox includes means to evacuate the grease drained thereto from the cooking process. In some embodiments, vertically disposed brackets are employed along the vertical side walls for supporting burner tubes, cooking or rock grates, burner shields, and other components.

Conventional burner tubes are normally designed with an open end for the ingress of a combustible gas-air mixture. The opposite end is closed and holes or ports are distributed along the walls of the normally circular tubes. The closed ends are normally stamped with flat ledges which are then secured to horizontally disposed ledges or tabs in the firebox.

The present design differs from conventional designs in that both ends of the burner tubes are stamped vertically and the burner is mounted so that the stamping and/or venturi on both ends are disposed in a vertical orientation. This presents a greatly reduced profile that does not impede the drainage of grease generated in the cooking process.

As shown in the drawings, the venturis and the burner mounting brackets are rotated ninety degrees (90°) from horizontal, further reducing the profile of the burner system, whether it comprises a single tube, multiple tubes, or burners with other configurations.

Covering the burner tubes are generally V-shaped tents formed from metal, ceramic, or other heat resistant and heat radiating material. The tents prevent grease from impinging on the burner tubes as the burner ports need to be sheltered from drippings of the food being cooked thereabove.

As shown in the drawings, the tents extend lengthwise, spanning the firebox while disposed above the burner tubes. While most such tents are designed with an angle of thirty to forty-five, (30°-45°), the present design presents an angle of approximately sixty degrees, (60°). The steeper pitch on the sides of the tents contributes to the vertical designs of the present firebox and hastens the drainage of grease which impinges on the tents.

Barbecue grills by nature tend to be hotter in the rear areas compared to the front. To address this condition, the present burner tents are mounted at an angle in which the tents slope downwardly from the front of the grill toward the rear. Having the heat-radiating tents higher in the front, and thus closer to the food being grilled, evens out the heat at the grate level. Thus, the cooking temperature is more uniform between the front and the rear of the cooking grate. This effect occurs despite the fact that the radiant tents are lower toward the rear of the grill, and thus closer to the burner flames, as the upwardly sloping tents channel the increased temperatures toward the front of the grill.

Disposed above the burner tents is the cooking surface upon which the food to be grilled is placed. In the embodiment shown by the drawings, the cooking grates are seamless. The ends of the cooking grates are bent downwardly at approximately ninety degrees (90°), such that the end cross bars are attached at a point further from the cooking surface. The center support cross bar is also spaced downwardly from the cooking surface, being supported by extended tabs or lugs that are attached to the rods that support the food.

This design eliminates the intersections of the food supporting rods and the rod-supporting cross bars. Thus, a seamless cooking surface is presented for more even grilling performance and greatly facilitating cleaning the grate, as there are no impediments to the cleaning tools. The design is equally compatible with wire rod grates, cast iron grates, stainless steel bars, and other designs.

The present cooking system for gas-fired barbecue grills, integrated into a barbecue grill with a lower firebox and upper lid, may be mounted on a mobile platform, such as a wheeled cart, or it may be stationary, such as in an outdoor island cooking structure. A side burner may also be integrated into the design.

Various additional objects and advantages of the present disclosure will be illustrated and described in detail hereinbelow.

### BRIEF DESCRIPTION OF THE DRAWINGS

FIG. 1 is a partial, front elevational view showing the firebox, burner tubes, burner shields, and cooking grate;

FIG. 2 is a cross-sectional view, taken along line 2-2, showing the orientation of the burner shields;

FIG. 3 is a partial front elevational view showing the burner tube and burner shield attachment parts;

FIG. 4 is a partial perspective view showing an alternate embodiment of the present system;

FIGS. 5A and 5B are schematic views of the front and rear walls, respectively, of the firebox;

FIGS. 6A and 6B are schematic views of the left side and right side walls, respectively, of the firebox;

FIG. 7 is a perspective view showing the new burner tube design;

FIG. 8 is a perspective view showing the new gas collection flame crosser;

FIG. 9 is a perspective view showing the new burner shield;

FIG. 10A is a partial, perspective view of the firebox assembly;

FIG. 10B is a cross-sectional view, taken along line 10A-10A, showing the geometry of the firebox;

FIG. 10C is a schematic representation of the angles of the heat radiant bars;

FIG. 11 is a perspective view of the grease drain pan;

FIG. 12A is a perspective view of an embodiment of a new cooking grate design;

FIG. 12B is a partial, perspective view showing an alternate embodiment of a new cooking grate design; and

FIG. 12C is a partial, perspective view showing the attachment point for a food-supporting rod and the cooking grate frame.

### BRIEF DESCRIPTION OF THE DRAWINGS

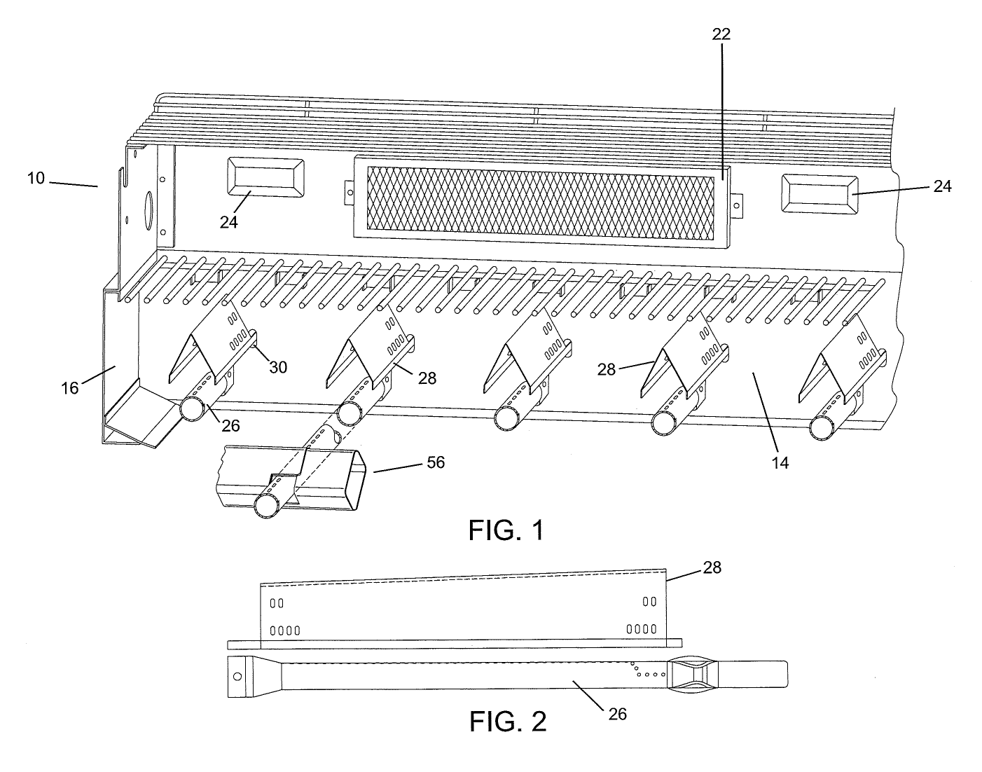

Referring now more specifically to the drawings, and to FIG. 1 in particular, numeral 10 designates generally the present vertical-walled firebox. The firebox has a front wall 12, rear wall 14, left side wall 16, and right side wall 18. The rear wall 14 has outwardly extending louvers 20 serving as air intakes for the combustion process and also as exhaust vents for smoke produced during grilling. All of the walls of the firebox are substantially vertical in orientation, thus ensuring that any grease or other substance impinging on the walls is directed downwardly, toward and into a grease tray.

The firebox shown in FIG. 1 includes a rotisserie burner 22 and lights 24. As with other features of the present cooking system, the rotisserie burner and lights are recessed into the rear wall so as not to impede the downward flow of grease and/or cooking debris.

As shown in FIG. 1, and discussed in greater detail hereinbelow, the present cooking system includes a plurality of burner tubes 26 that, in this embodiment, span the depth of the firebox from front to rear. The tubes 26 can also be configured to span the firebox from side to side, and such is included within the scope of this disclosure. Disposed above each burner tube is a burner shield 28. The outer ends of the burner shields are received into a series of spaced oval slots 30 that are formed in the front and rear walls, or in the side walk, depending on the orientation of the burner tubes. The oval slots obviate the need for ledges or other protrusions that are commonly used to support such burner shields.

In some embodiments, the BTU output from the burner tubes at or near the center of the grill can be reduced by anywhere from ten to thirty percent (10%-30%). This can be done through reducing the size of the tube itself, reducing the size or number of burner ports, or by adjusting the valve settings. This serves to even out the heat in the firebox as the center of the grill tends to be hotter than the peripheral areas.

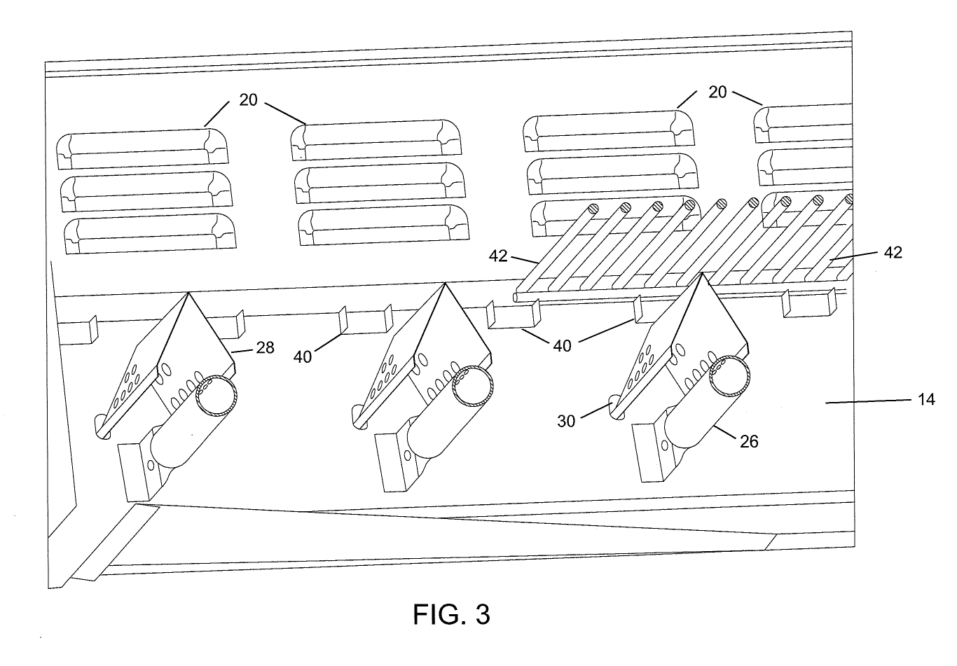

FIG. 2 is a cross-section of the firebox of FIG. 1. The burner shields slope downwardly from the front of the firebox toward the rear. As noted above, grills tend to be hotter at the rear of the firebox than in the front. Sloping the shields in this manner evens out the heat across the cooking surface. Heat generated from combustion travels upwardly along the burner shield toward the normally cooler front portion. Additionally, as the burner shields themselves absorb and radiate heat, disposing the shields closer to the cooking surface at the cooler front section, thus closer to the food being cooked, further evens out the heat across the cooking grate. The degree of sloping of the burner shields can vary with different firebox configurations, but is typically within a range of one to twenty-five degrees, (1°-25°). Put another way, the front end of the burner shield is raised from 5 mm to 25 mm above the lower end at the rear of the firebox.

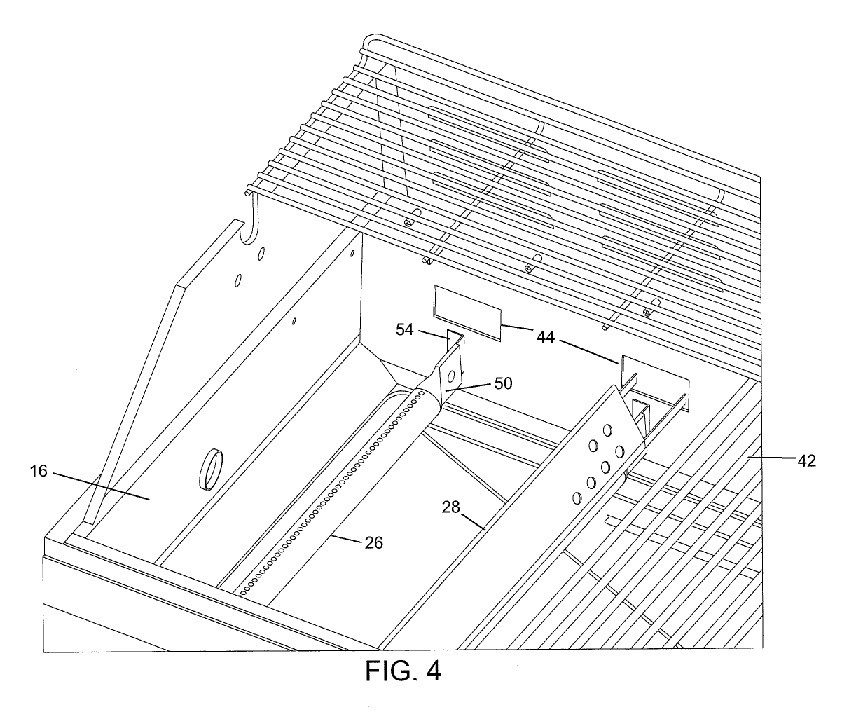

In FIG. 3, U-shaped brackets 40 are secured to the rear wall 14, (and the front wall 12, not shown), for supporting a cooking grate 42. As with the other fixtures in the present cooking system, the brackets 40 present minimal horizontal surface area where grease and debris may collect.

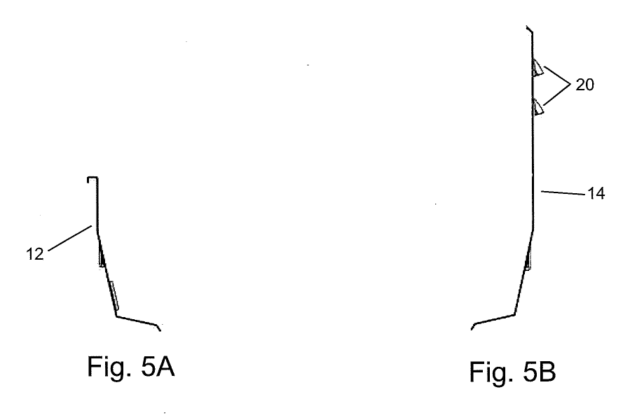

FIG. 4 illustrates an alternate embodiment in which rectangular cut-outs 44 are provided in the rear wall, (and front wall, not shown), in place of the oval slots 30. The cut-outs are used for supporting the burner shields and present no obstacle to the draining of grease or debris toward the bottom of the firebox.

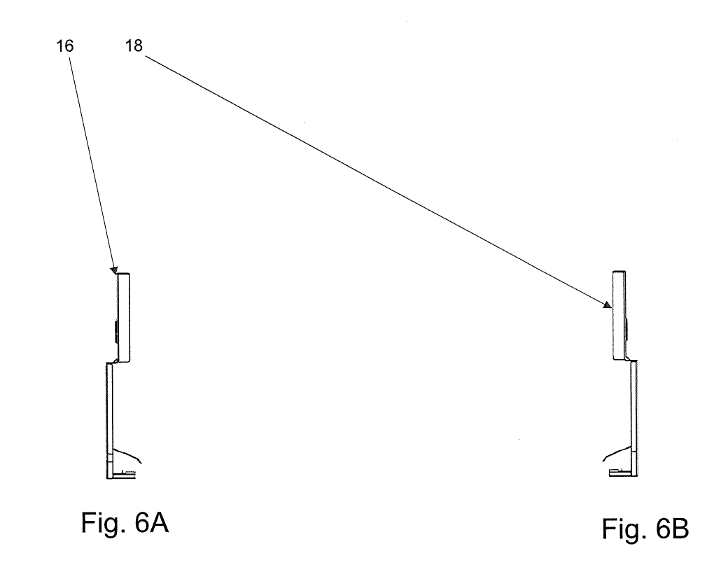

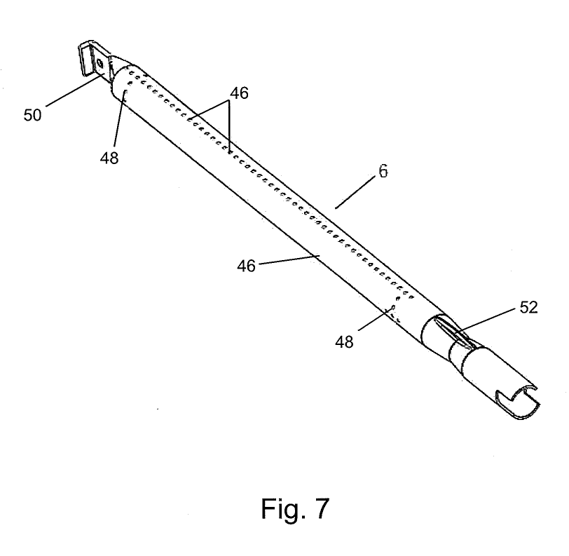

FIGS. 5A and 5B show, respectively, profile views of the front wall 12 and the rear wall 14 of the present firebox. FIGS. 6A and 6B show, respectively, the left side 16 and right side wall 18 of the firebox. As can be seen, the wall surfaces are predominantly vertical in orientation, with minimal sloping toward the center at the lowermost reaches of the wall surfaces for funneling grease or cooking debris toward the drain pan, (discussed hereinbelow).

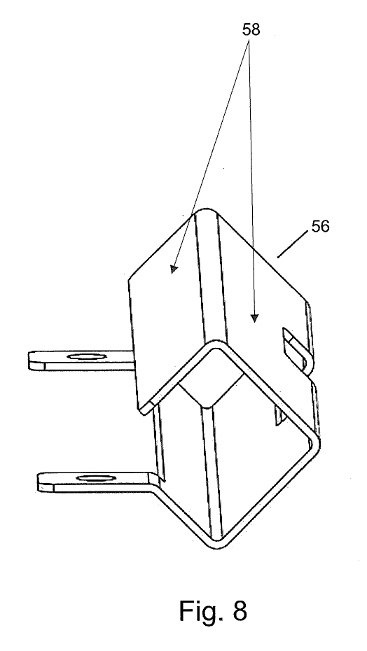

An individual burner tube 46 is shown in FIG. 7. Tube 46 has upwardly facing ports 46 through which the combustible gas-air mixture is emitted and burned. A series of additional ports 48 are disposed at each end of the tube for facilitating initial ignition and cross-over ignition of adjacent burner tubes. As noted earlier, most burner designs have flat, horizontally oriented end stampings. While this makes it easy to secure the burners in the firebox, the horizontal ends collect grease and debris. The present tubes have a vertically oriented stamping 50 at the closed end and a vertically oriented venturi 52 at the open end. The closed end is secured in place using a vertically oriented L-shaped bracket 54 (FIG. 4), and screws, pins, or any like fastening means. The vertical orientation of the burner tube ends prevents grease or debris from collecting on or around these areas.

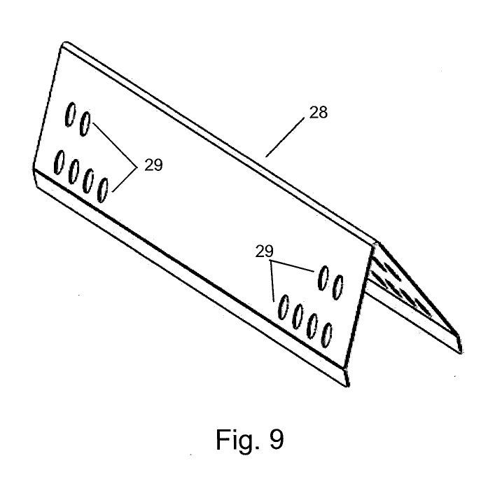

In FIG. 8 is illustrated a flame crosser through which multiple burner tubes are ignited using a crossover pipe or the like. Typically, boxes like this have a flat top surface and are generally square or rectangular in shape. As can be seen, the top surfaces 58 are oriented at an extreme downward angle to prevent any accumulation of grease or debris. The crosser can be of any length, spanning a single burner or multiple burners. An example of the mounting is shown in FIG. 1. The crosser can be mounted along the front wall or the rear wall.

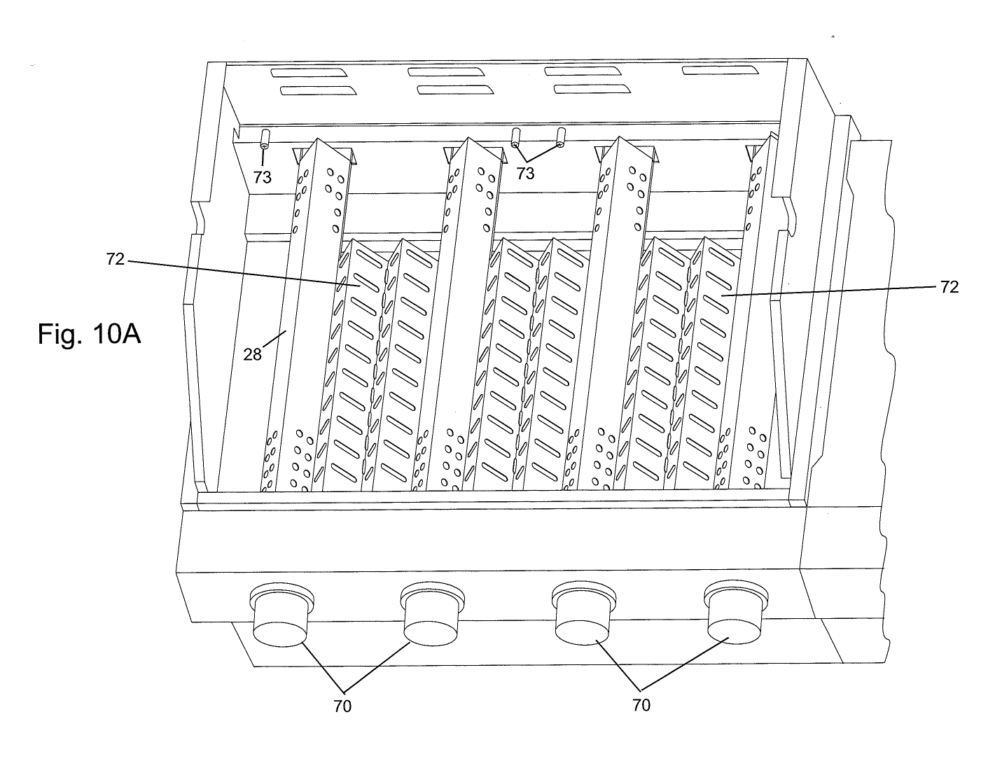

FIG. 9 shows an individual burner shield 28. While prior art designs have such shields in various configurations, they are designed with angles of from about thirty to forty-five degrees (30°-45°). The present shields have a much steeper angle, within a range of about sixty to seventy-five degrees (60°-75°). The extreme angle ensures that grease and debris are directed downwardly as opposed to accumulating on the surface of the shields. At least one or a plurality of apertures 29 are provided at each end of the burner shields for a user to be able to view the flame and ensure the burner is lit. The apertures also serve to help in heat distribution throughout the firebox.

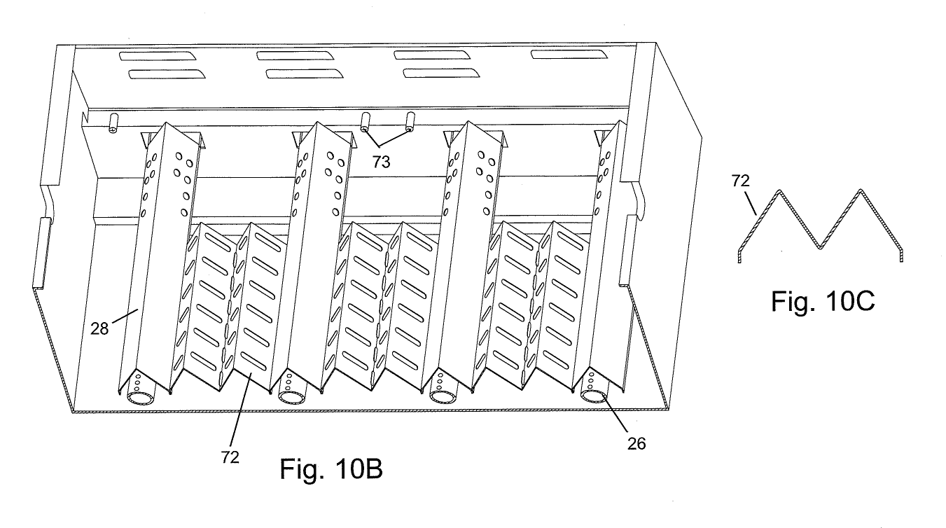

FIGS. 10A, 10B, and 10C illustrate the present cooking system in what is close to a fully-assembled configuration. The burner tubes 26 are secured in place and in communication with the on-off valve controls 70. Disposed below the burner tubes are generally V-shaped bars 72 which absorb and radiate convective heat. The bars 72 may be individual members or they can be connected to form a single, corrugated, radiant substrate. While prior art grills have provided similar radiant means, they are typically flattened, as opposed to the present design where the angle is greater than sixty degrees, (60°). This extreme angle also sheds grease and debris toward the bottom of the firebox.

An alternate embodiment for mounting the cooking grates is also shown in FIGS. 10A and 10B. Here, the U-shaped brackets 40 are replaced by lugs 73 which may be welded in place, threaded so as to screw in to the firebox walls or otherwise secured. Here again, the lugs can have a tented profile for shedding grease, and, in any event, provide a minimal profile for collecting grease or debris.

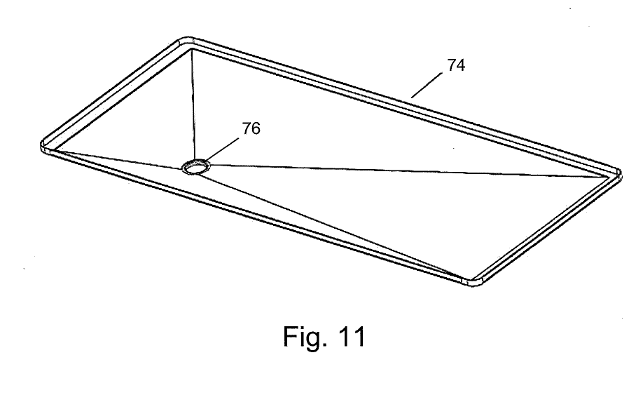

Grease and debris from cooking eventually end up in a grease tray 74, shown in FIG. 11. The grease tray is deeply drawn and angles from any direction toward a drain hole 76. While most grills have a grease tray, the present design has no flat ledge or flat area around the hole to prevent any accumulation of grease or debris.

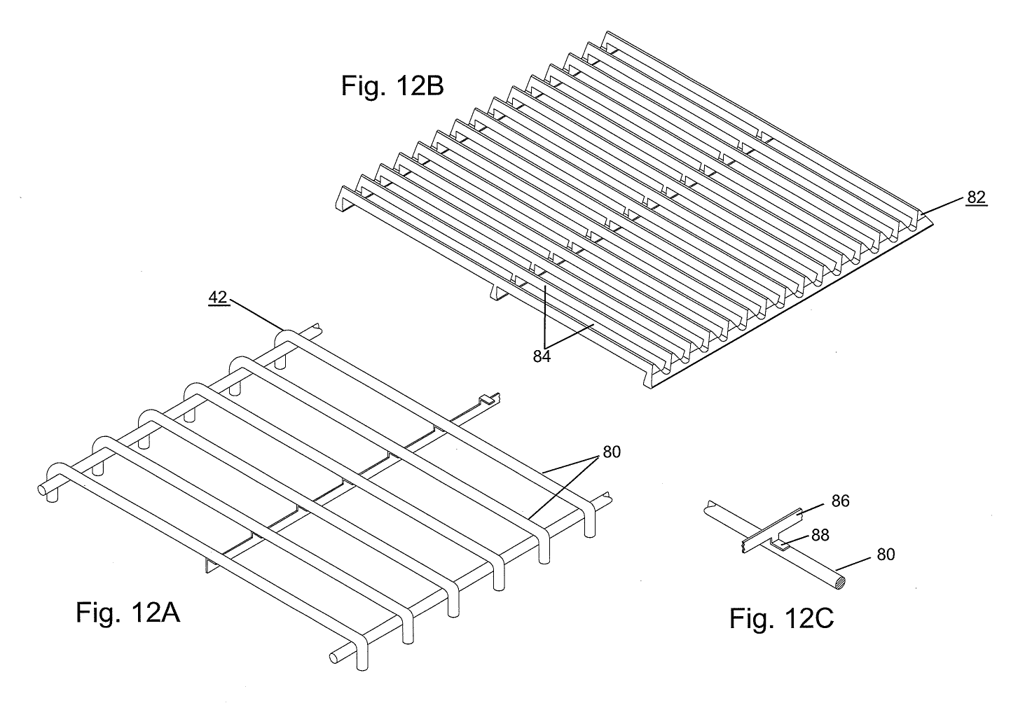

FIGS. 12A, 12B, and 12C illustrate the improved cooking grates for the present cooking system. The grate 42 in FIG. 12A has a plurality of rods 80 while the grate 82 shown in FIG. 12B has a plurality of bars 84. Both designs provide a seamless upper surface. Support for the rods or bars is provided by cross bars 86 that have an extended profile so as to be spaced from the top surfaces. The cross bars have a tab 88 that connects to the rod or bar thereabove. This provides for easier cleaning of the grates as there are no intersecting points that could accumulate grease or debris. The outer ends of the rods or bars are also angled downwardly to shed grease or debris.

While an embodiment of a barbecue grill cooking system and modifications thereto have been shown and described in detail herein, various additional changes and modifications may be made without departing from the scope of the present disclosure.

I claim:

1. A barbecue grill cooking system comprising a firebox having front, rear, right side and left side walls, said walls all disposed substantially vertically to facilitate grease drainage and at least one burner disposed in said firebox and having an inlet, a venturi, and a closed end opposite said inlet, said closed end and said venturi having a vertical orientations for facilitating grease drainage.

2. A barbecue grill cooking system as defined in claim 1 and including a vertically oriented tab secured to said near wall for supporting said burner.

3. A barbecue grill cooking system as defined in claim 1 and including a vertically oriented bracket secured to said rear wall and a second vertically oriented bracket secured to said front wall, said brackets being mounted above the level of said burner, and a burner shield disposed on said brackets for preventing grease impingement on said burner.

4. A barbecue grill cooking system as defined in claim 1 and including a cooking grate disposed over said burner, said cooking grate having a supporting frame with a plurality of vertically extending tabs, and a plurality of food supporting members secured to said tabs for spacing said members from said frame.
